(19) United States
(12) Patent Application Publication
(10) Pub. No.: US 2013/0057079 A1
(43) Pub. Date: Mar. 7, 2013

(54) APPARATUS AND METHOD OF CONTROLLING WIRELESS POWER TRANSMISSION

(71) Applicants: Se-Ho PARK, Suwon-si (KR); Ki-Hyun Kim, Suwon-si (KR); Joon-II Kim, Seoul (KR); Jin-Hyoung Park, Wonju-si (KR); Kyung-Woo Lee, Seongnam-si (KR); Woo-Ram Lee, Hwaseong-si (KR)

(72) Inventors: Se-Ho PARK, Suwon-si (KR); Ki-Hyun Kim, Suwon-si (KR); Joon-II Kim, Seoul (KR); Jin-Hyoung Park, Wonju-si (KR); Kyung-Woo Lee, Seongnam-si (KR); Woo-Ram Lee, Hwaseong-si (KR)

(73) Assignee: Samsung Electronics Co., Ltd.

(21) Appl. No.: 13/605,381

(22) Filed: Sep. 6, 2012

Related U.S. Application Data
(60) Provisional application No. 61/531,789, filed on Sep. 7, 2011.

(30) Foreign Application Priority Data
Jan. 10, 2012 (KR) 10-2012-00002960

(51) Int. Cl. H02J 17/00

(52) U.S. Cl. 307/104

(57) ABSTRACT

An apparatus for controlling wireless power transmission includes a near-field wireless communication antenna for receiving wireless power transmission control signals from a power transmitting device at a communication frequency, a near-field wireless communication Integrated Circuit (IC) for delivering wireless power transmission control messages based on the wireless power transmission control signals received through the near-field wireless communication antenna to a power IC, a Wireless Power Transmission (WPT) coil for resonating at a frequency band corresponding to a resonant frequency of the power transmitting device, to receive power supplied from the power transmitting device, and the power IC for controlling output of a constant voltage, using the supply power received by the WPT coil, based on the wireless power transmission control messages from the near-field wireless communication IC.

### PRIORITY

This application claims priority under 35 U.S.C. §119(a) to a United States Patent Application filed in the United States Patent and Trademark Office on Sep. 7, 2011 and assigned Ser. No. 61/531,789, and a Korean Patent Application filed in the Korean Intellectual Property Office on Jan. 10, 2012 and assigned Serial No. 10-10 2012-0002960, the entire disclosure of which is incorporated herein by reference.

### BACKGROUND OF THE INVENTION

1. Field of the Invention

The present invention relates generally to an apparatus and method of controlling wireless power transmission, and more particularly, to an apparatus and method of controlling wireless power transmission via near-field wireless communication channels.

2. Description of the Related Art

As a variety of portable electronic products are being introduced, and along with the development of Information Technology (IT), many different technologies to power portable electronic products are being developed. In the past, power lines were mainly used to power technology, but in recent days, wireless power transmission technology is being actively developed.

The technology of wireless power transmission refers to technology that delivers electrical energy in the form of electromagnetic waves, electromagnetic induction or resonance, and which enables the electric power to be supplied anywhere and at any time without a power line, such as a power cable. The wireless power transmission, a key technology for wireless recharging of electronic devices, wireless power supply and recharging of electronic vehicles, power supply of ubiquitous wireless sensors, intends to replace existing wired power supply and recharging technology.

Where the wireless power transmission is used in a wireless recharging system, the wireless recharging system consists of a power transmitting device for supplying power and a power receiving device configured to receive the power to recharge the battery. The power transmitting device measures a value of a changed load or a value of changed resonant frequency in a standby state of wireless recharging, to detect if an object is placed on a source resonant unit. If the object is detected, the power transmitting device supplies power to the object by transmitting power necessary for recharging, and determines whether it is an object to be wirelessly recharged or is another metal object, via an authentication process, such as an ID exchange with the object. If the authentication is successful, the power transmitting device determines that the object placed on the source resonant unit is a wirelessly chargeable charger, namely, a power receiving device, and then negotiates with the power receiving device over power transmission. When the negotiation is completed, the power receiving device starts to be recharged. After a while, the power transmitting device checks if the power receiving device has been completely recharged, and if so, stops transmitting power to the power receiving device.

As described above with reference to the wireless charging system, when the power transmitting device and the power receiving device negotiate over power transmission, in-band communication is used for communication between them. The in-band communication refers to a method of using an identical frequency band for a power transmission frequency band and a communication frequency band between the power transmitting device and the power receiving device. However, with the in-band communication where the power supply frequency band and the communication frequency band is the same, different limitations apply to signal_strengths of the power supply frequency band and the communication frequency band. For example, the Federal Communication Commission (FCC) authenticated standard limits of the signal strength of the power transmission frequency band to 42 dBmA/m or less and requires the signal strength of the communication frequency band to be 15 dBmA/m, when the bands operate using a 6.78 MHz band. Thus, for in-band communication, if the signal strength of the power transmission frequency band is higher than a predetermined level, the requirement of the signal strength of the communication frequency band cannot be met, so the problem of inappropriate control of the wireless power transmission arises.

Accordingly, out of band communication is used instead, to avoid the limitations of strengths of the power transmission and communication signals by differing the power transmission frequency band from the communication frequency band. The out of band communication refers to a method of using different power transmission frequency bands and communication frequency bands between the power transmitting device and the power receiving device.

Even with the out of band communication, available frequency bands are limited, because the available frequency band is predetermined, such as in the Industrial Scientific Medical (ISM) band. The ISM band is available for industrial, scientific, and medical devices, and the ITU-R has designated 13.55313.567 MHz, 26.97527.283 MHz, 10 40.6640.70 MHz, 433.05433.79 MHz, 902928 MHz, 2.42.48 GHz, 5.7255.875 GHz, 2424.25 GHz, 6161.5 GHz, 122123 GHz, 244246 GHz for the ISM band.

Recently, as the ISM band is allowed for use as the communication frequency band for low-power wireless devices that require no license, the ISM band utility is increasing. Therefore, it would be efficient if the power transmitting device and the power receiving device use different frequency bands for the power transmission frequency band and the communication frequency band, but use a frequency among available frequencies in the ISM band, which is not limited by strengths of power transmission signals and communication signals.

### SUMMARY OF THE INVENTION

The present invention has been made to solve the above-stated problems and/or disadvantages and to provide at least the advantages described below. Accordingly, an aspect of the present invention is to provide an apparatus and method of controlling wireless power transmission with which a power transmitting device and a power receiving device use different frequency bands for a power supply frequency band and a communication frequency band, but use as the communication frequency band for controlling the power transmission a frequency among available frequencies in the ISM band, which is not limited by strengths of power transmission signals and communication signals.

According to an aspect of the present invention, there is also provided an apparatus and method of controlling wireless power transmission with which a power transmitting device and a power receiving device use different frequency bands for a power transmission frequency band and a communication frequency band, but use as the communication frequency band for controlling the power transmission a frequency among available frequencies in the ISM band, which is not limited by strengths of power transmission signals and communication signals, the apparatus and method using a Near Field Communication (NFC) scheme.

According to one aspect of the present invention, there is provided an apparatus configured to control wireless power transmission, which includes a near-field wireless communication antenna configured to receive wireless power transmission control signals from a power transmitting device at a communication frequency, a near-field wireless communication Integrated Circuit (IC) configured to deliver wireless power transmission control messages based on the wireless power transmission control signals received through the near-field wireless communication antenna to a power IC, a wireless power transmission (WPT) coil configured to resonate to a frequency band identical to a resonant frequency of the power transmitting device, to receive supply power from the power transmitting device, and the power IC configured to output a constant voltage, using the supply power received by the WPT coil based on the wireless power transmission control messages from the near-field wireless communication IC.

According to another aspect of the present invention, there is provided a method of controlling wireless power transmission, which includes receiving wireless power transmission control signals from a power transmitting device through a near-field wireless communication antenna at a communication frequency, delivering wireless power transmission control messages based on the received wireless power transmission control signals to a power Integrated Circuit (IC), and outputting a constant voltage, using supply power received by a WPT coil based on the wireless power transmission control messages.

### BRIEF DESCRIPTION OF THE DRAWINGS

The above and other aspects, features and advantages of the present invention will be more apparent form the following detailed description with reference to the accompanying drawings, in which:

FIG. 1 is a diagram illustrating a communication scheme for controlling power transmission between a power transmitting device and a power receiving device, according to an embodiment of the present invention;

FIG. 2 is a diagram illustrating a wireless power transmission system, according to an embodiment of the present invention;

FIG. 3 is a diagram illustrating an apparatus for controlling wireless power transmission, according to an embodiment of the present invention;

FIGS. 4A and 4B are circuit diagrams illustrating the apparatus for controlling wireless power transmission, according to an embodiment of the present invention; and

FIGS. 5A and 5B are circuit diagrams illustrating the apparatus for controlling wireless power transmission, according to another embodiment of the present invention.

### DETAILED DESCRIPTION OF THE EMBODIMENTS OF THE PRESENT INVENTION

Hereinafter, various embodiments of the present invention are described, with reference to the accompanying drawings. In the following description, like reference numerals refer to like elements, features and structures, throughout the drawings. Detailed description of known functions and configurations is omitted to avoid obscuring the subject matter of the present invention.

The present invention provides an apparatus and method of controlling wireless power transmission for controlling wireless power transmission using as a communication frequency band, a frequency band different from a power transmission frequency band, which belongs to an Industrial Scientific Medical (ISM) band, between power transmitting and receiving devices. Specifically, the present invention provides an apparatus and method of controlling wireless power transmission, using a 13.56 MHz band as the communication frequency band, among frequency bands that belong to the ISM band between power transmitting and receiving devices, and using a wireless Near Field Communication (NFC) scheme. The present invention provides wireless recharging for electromagnetic devices, wireless power transmitting and recharging for electric vehicles, power transmitting for ubiquitous wireless sensors, and any other devices that perform wireless power transmission. In this description, devices for providing wireless power are referred to as power transmitting devices, and devices configured to receive wireless power are referred to as power receiving devices. Structural and operational principles of the present invention are described below, along with power transmitting and receiving devices according to the present invention.

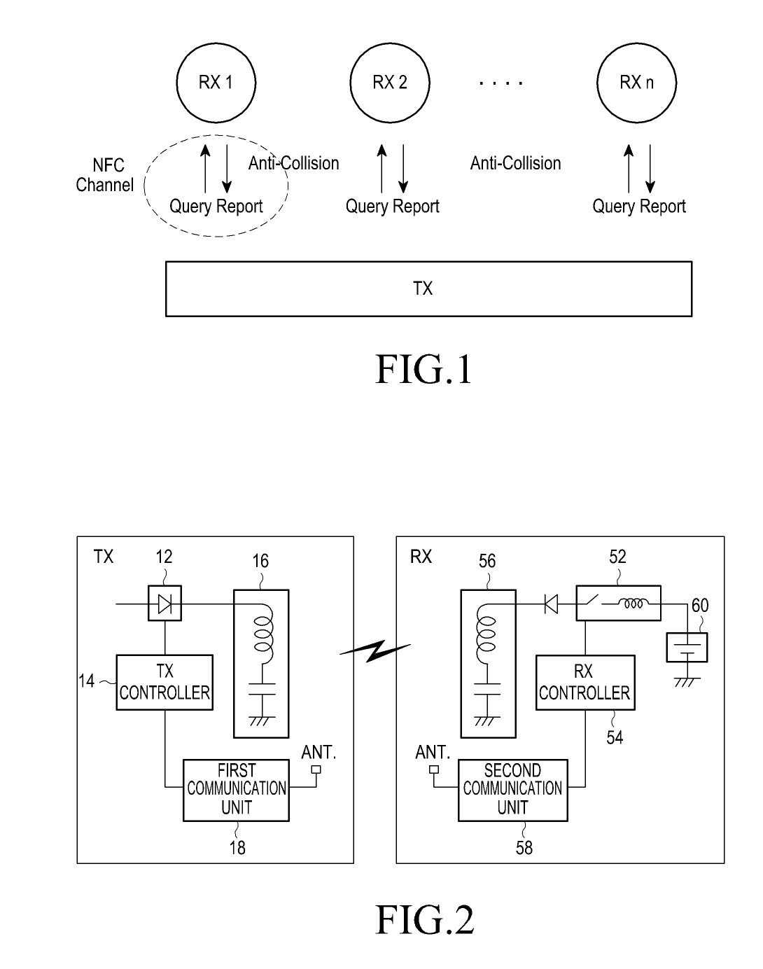

FIG. 1 is a diagram illustrating a communication scheme for controlling power transmission between a power transmitting device and a power receiving device, according to an embodiment of the present invention.

Referring to FIG. 1, the power transmitting device TX wirelessly supplies power to each of a plurality of power receiving devices RX1˜RXn. Each of the power transmitting devices TX and the plurality of power receiving devices RX1˜RXn communicates in a near-field wireless communication scheme, e.g., an NFC communication scheme, using a 13.56 MHz band, and controls wireless power transmission via an NFC channel. For example, the power transmitting device TX communicates with a power receiving device RX1 by sending a query to the power receiving device RX1 in a master's position based on a master-slave scheme and receiving a report from the power receiving device RX1. In order to prevent collisions of transmission and reception in the communication between the power transmitting device TX and the plurality of the power receiving devices RX1˜RXn, queries are sent at a predetermined interval of time.

FIG. 2 is a diagram illustrating the power transmitting and receiving devices, according to an embodiment of the present invention. Referring to FIG. 2, the power transmitting device TX includes an amplifier 12, a TX controller 14, a TX resonator 16, a first communication unit 18, an antenna ANT.

The TX controller 14 controls general operations of the power transmitting device TX, and especially each component of the power transmitting device TX in the process of wireless power transmission. The TX controller 14 also generates many different messages required for the wireless power transmission, and processes messages received from the power receiving device RX. Furthermore, during the entire process of wireless power transmission, the TX controller 14 calculates an amount of supply power to be transmitted through the TX resonator 16 based on information received from the power receiving device RX, and controls the amplifier 12 for the calculated amount of the supply power to be transmitted through the TX resonator 16. The TX resonator 16 includes a resonance coil to resonate to a frequency identical to that of the RX resonator 56 of the power receiving device RX to transmit the supply power to the power receiving device RX. The first communication unit 18 performs NFC communication with the power receiving device RX under the control of the TX controller 14, to output the message received from the power receiving device RX to the TX controller 14 and transmit a message from the TX controller 14 to the power receiving device RX.

The power receiving device RX that receives power from the power transmitting device TX includes a rectifier 52, an RX controller 54, an RX resonator 56, a second communication unit 58, and a charger 60.

The RX resonator 56 includes a resonance coil to resonate to the same frequency as that of the TX resonator 16 of the power transmitting device TX to receive the supply power from the TX resonator 16 at the resonant frequency. The rectifier 54 rectifies the received supply power, to charge the charger with the power. The RX controller 54 controls general operations of the power receiving device RX, and be configured as a power Integrated Circuit (IC). The RX controller 54 controls operations of each component of the power receiving device RX in the wireless power receiving and recharging procedure. The RX controller 54 also generates many different messages required for the wireless power receiving and recharging, and processes messages received from the power transmitting device TX. Furthermore, the RX controller 54 receives drive voltage from the rectifier 52 and activates general operations of the power receiving device RX. It also measures current and voltage of a signal output from the rectifier 52 and accordingly controls operations of the rectifier 52, during the wireless recharging process. The second communication unit 58 performs communication with the power transmitting device TX under the control of the RX controller 54, to deliver the message received from the power transmitting device TX to the RX controller 54 and transmit a message input from the RX controller 54 to the power transmitting device TX. The second communication unit 58 is configured using a near-field wireless communication scheme, e.g., with an NFC IC, and communicates through an NFC channel.

According to an embodiment of the present invention, the power transmitting device TX and the power receiving device RX use different frequency bands for a power supply frequency band (resonant frequency band) and a communication frequency band, and controls the wireless power transmission with the near-field wireless communication, which is the NFC communication.

A structure of an apparatus 100 for controlling wireless power transmission when the apparatus 100 is included in the power receiving device RX is described below.

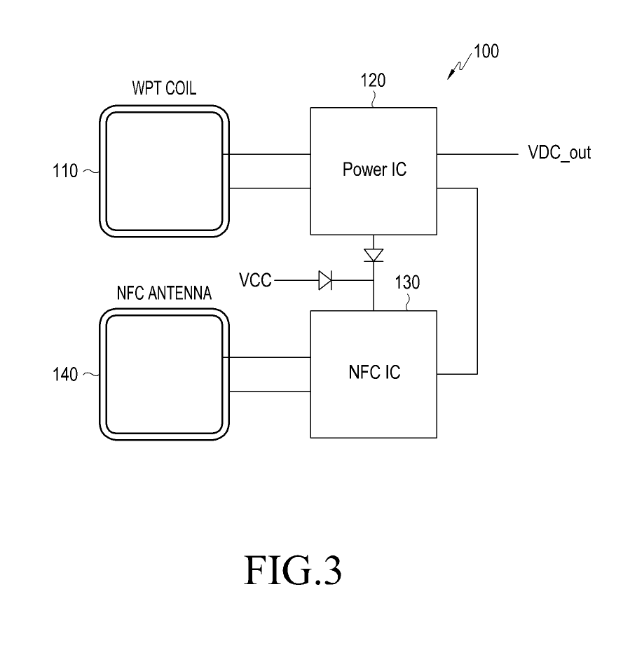

FIG. 3 is a diagram illustrating the apparatus 100 for controlling wireless power transmission, according to an embodiment of the present invention. Referring to FIG. 3, the apparatus 100 includes a Wireless Power Transmission (WPT) coil 110, a power IC 120, an NFC IC 130, and an antenna 140.

The WPT coil 110 corresponding to the RX resonator 56 includes a resonance coil to resonate to the same frequency as that of the TX resonator 16 to receive the supply power at the resonant frequency.

The power IC 120 integrates functionalities of the RX controller 54 and the rectifier 52 and controls operations of each component for the wireless power reception. The power IC 120 generates many different signals required configured to receive the wireless power, and operates according to wireless power transmission control signals based on messages received from the power transmitting device TX. In addition, the power IC 120 activates general operations of the apparatus 100 using voltage based on the power received by the WPT coil 110. While being supplied with the power, the power IC measures and regulates current and voltage obtained from the supply power, and outputs a constant supply voltage VDC out.

The NFC IC 130 corresponds to the second communication unit 58, and operates with the power provided by the power IC 120 and performs NFC communication with the power transmitting device TX through the NFC antenna 140. The NFC antenna 140 delivers the wireless power transmission control signals to the power IC 120 according to the messages received from the power transmitting device TX. The wireless power transmission control signals include control signals required for wireless power transmission, such as signals to start and stop the wireless power transmission.

According to an embodiment of the present invention, as described above with reference to the apparatus for controlling wireless power transmission, the NFC IC 130 and the NFC antenna 140 communicates using the 13.56 MHz band as a communication frequency band among the frequency bands that belong to the ISM bands, and the WPT coil 110 and the power IC 120 receives the wireless power using a frequency band different from the communication frequency band.

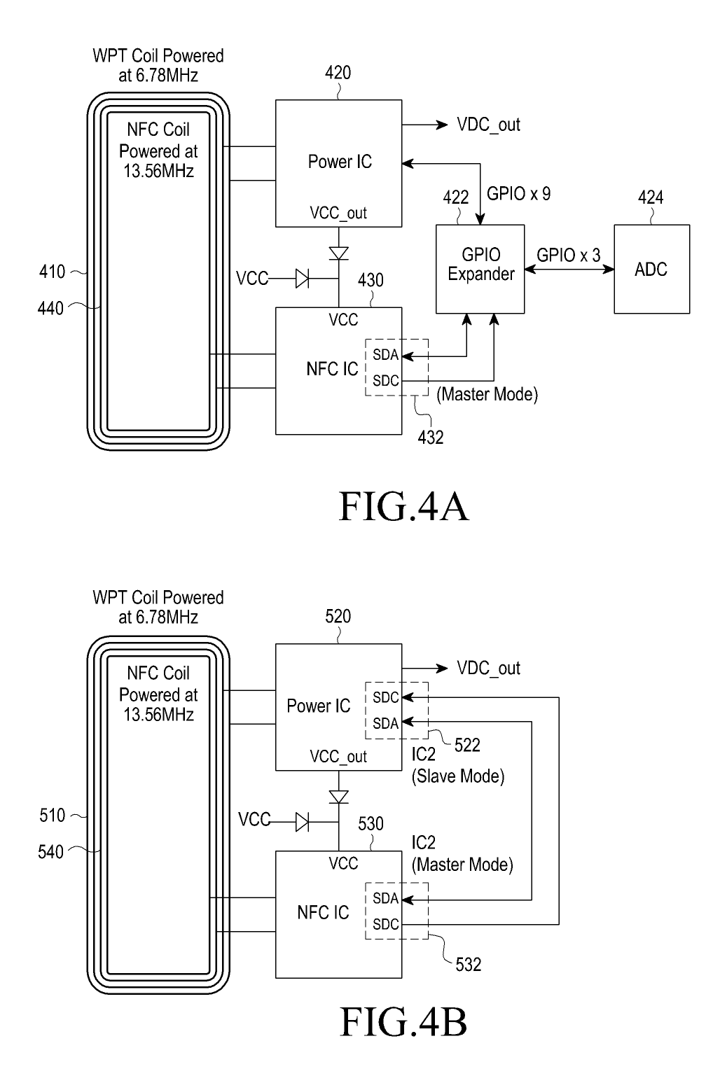

FIGS. 4A and 4B are circuit diagrams illustrating the apparatus 100 for controlling wireless power transmission using 6.78 MHz for the power transmission frequency band, according to an embodiment of the present invention. Referring to

FIGS. 4A and 4B, the apparatus 100 is not affected by limitations even if the strength of power transmission signals and communication signals is raised, by using a 13.56 MHz band for the communication frequency band and a 6.78 MHz band for the power transmission frequency band, which is different from the communication frequency band.

In an apparatus where the 13.56 MHz band is used for the communication frequency band and the 6.78 MHz band for the power transmission frequency band, which is different from the communication frequency band, a specific circuitry of the apparatus 100 may be configured differently. For example, as illustrated in FIG. 4A, a separate component for transmitting to and receiving from the NFC IC 140 the wireless power transmission control signals are configured outside of the power IC 120, or as illustrated in FIG. 4B, the power IC 120 communicates the wireless power transmission control signals with the NFC IC 140 without a separate component.

Referring to FIG. 4A, the apparatus 100 for controlling the wireless power transmission includes a WPT coil 410, an NFC coil 440, a power IC 420, a General Purpose Input/Output (GPIO) expander 422, an Analog-to-Digital Converter (ADC) 424, and an NFC IC 430.

The WPT coil 410 is connected to the power IC 420, and resonates in a 6.78 MHz frequency band to be powered from the power transmitting device TX and to provide the power to the power IC 420. The power IC 420 generates many different signals required for receiving the wireless power, and operates according to wireless power transmission control signals based on messages received from the power transmitting device TX. In addition, the power IC 420 activates general operations of the apparatus 100 using voltage based on the power received by the WPT coil 410. While being powered, the power IC measures and adjusts current and voltage obtained from the supply power, and outputs a constant voltage VDC_out.

The GPIO expander 422 is an input/output module between the power IC 420 and the NFC IC 430 for inputting a signal output by the power IC 420 to the NFC IC 430 and inputting a signal output by the NFC IC 430 to the power IC 420. The ADC 424 adjusts signal transmission and reception between the power IC 420 and the NFC IC 430 by converting analog signals to digital signals or vice versa for signals communicated between the power IC 420 and the NFC IC 430.

The NFC IC 430 operates on the power provided by the power IC 420, and performs the NFC communication with the power transmitting device TX through the NFC coil 440. The NFC coil 440 is configured as an NFC coil capable of RF emission and reception in the 13.56 MHz band. The NFC IC 430 analyzes a signal received from the power transmitting device TX via the NFC antenna 440 and delivers wireless power transmission control signals based on the received signal to the power IC 420, using the NFC IC input/output unit 431. The NFC IC input/output unit 431 includes Serial Data (SDA) and Serial Clock (SDC) terminals. The SDA terminal inputs or outputs data for controlling the wireless power transmission, and the SDC terminal outputs a clock. Furthermore, according to an embodiment of the present invention, wireless power transmission control signals is necessary for the wireless power transmission, enabling control of voltage, current, temperature, etc.

Referring to FIG. 4B, the apparatus 100 for controlling wireless power transmission includes a WPT coil 510, an NFC coil 540, a power IC 520, an NFC IC 530 without the GPIO expander 422 and the ADC 424. The power IC 520 includes a power IC input/output unit 522 having SDA and SDC terminals, through which clocks and data for controlling the wireless power transmission are transmitted to and received from the NFC IC input/output unit 532. Similarly, wireless power transmission control signals according to an embodiment of the present invention is necessary for the wireless power transmission, enabling control of voltage, current, temperature, etc.

Although the 6.78 MHz and 13.56 MHz bands are used for the power transmission frequency band and the communication frequency band, respectively, as described above, alternatively the power transmission frequency band may also use a 100˜200 KHz band.

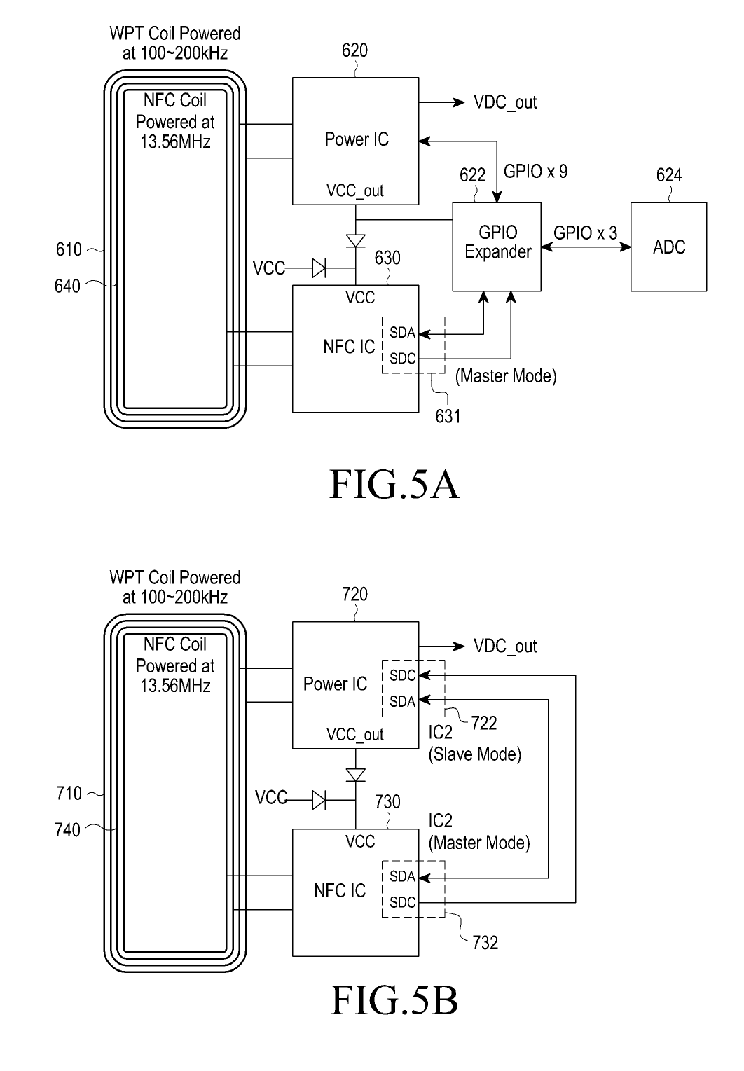

FIGS. 5A and 5B are circuit diagrams illustrating the apparatus 100 for controlling wireless power transmission using 100˜200 KHz for the power transmission frequency band, according to a second embodiment of the present invention.

Referring to FIG. 5A, The WPT coil 610 is connected to the power IC 620, and resonates in the 100˜200 KHz frequency band to be powered from the power transmitting device TX and provide the power to the power IC 620. Structures and operations of an NFC coil 640, a power IC 620, a GPIO Expander 622, an ADC 624, an NFC IC 630, and an NFC IC input/output unit 631 are the same as what are described in connection with FIG. 4A.

Referring to FIG. 5B, the WPT coil 710 is connected to the power IC 720, and resonates in a 200 KHz frequency band to be powered from the power transmitting device TX and provide the power to the power IC 720. Structures and operations of an NFC coil 740, a power IC 720, a GPIO Expander 622, an ADC 721, an NFC IC 730, and an NFC IC input/output unit 731 are identical to what are described in connection with FIG. 4A.

The apparatus 100, described above, for controlling the wireless power transmission according to an embodiment of the present invention communicates through the NFC IC 130 and the NFC antenna 140 using the 13.56 MHz band among frequency bands that belong to the ISM band while receiving wireless power through the WPT coil 110 and the power IC 120 using the 6.78 MHz or 100˜200 KHz band, which is different from the communication frequency band, thus reducing interference between power transmission signals and communication signals and avoiding being affected by a predetermined limitation on the signal strength.

As described above with reference to the apparatus 100 for controlling the wireless power transmission according to an embodiment of the present invention, the WPT coil and the NFC coil are arranged in an oval shape having the same center, with the NFC coil arranged relatively inside and the WPT coil arranged relatively outside, as relative to the oval. Alternatively, although not illustrated in the drawings, the WPT coil and the NFC coil are arranged in an oval shape having the same center, with the NFC coil arranged relatively outside and the WPT coil arranged relatively inside, as relative to the oval. Such an arrangement of the NFC coil and the WPT coil contributes to a reduction in an arrangement area for the apparatus 100 for controlling the wireless power transmission. Alternatively, the WPT coil and the NFC coil is arranged in parallel to each other, or arranged in any other ways.

According to the present invention, by using different frequency bands for communication frequency bands and the power transmission frequency bands the apparatus for controlling the wireless power transmission has an advantage of not being affected by regulations on strengths of power supply signals and communication signals even if the strengths are raised. The present invention also has an advantage of reducing interference of signals between the communication frequency band and the power transmission band by using the 13.56 MHz for the communication frequency band and the 6.78 MHz or 100˜200 KHz for the power transmission frequency band, which is different from the communication frequency band.

In the foregoing description the 6.78 MHz or 100˜200 KHz band is used for the wireless transmission frequency band, as one example, and alternatively, any of other frequency bands are used for the wireless transmission frequency band as long as the wireless transmission frequency band is different from the communication frequency band. In addition, the NFC coil and the WPT coil may be arranged in various ways.

While the present invention has been described with reference to various embodiments thereof, various modifications can be made without departing from the spirit and scope of the present invention, as defined by the appended claims and their equivalents.

What is claimed is:

1. An apparatus for controlling wireless power transmission, comprising:
a near-field wireless communication antenna for receiving wireless power transmission control signals from a power transmitting device at a communication frequency;
a near-field wireless communication Integrated Circuit (IC) for delivering wireless power transmission control messages based on the wireless power transmission control signals received through the near-field wireless communication antenna to a power IC;
a Wireless Power Transmission (WPT) coil for resonating at a frequency band identical to a resonant frequency of the power transmitting device, to receive supply power from the power transmitting device; and
the power IC for controlling output of a constant voltage, using the supply power received by the WPT coil based on the wireless power transmission control messages from the near-field wireless communication IC.

2. The apparatus of claim 1, wherein the near-field wireless communication includes Near Field Communication (NFC) communication.

3. The apparatus of claim 1, wherein the communication frequency band and the power transmission frequency band are different from each other.

4. The apparatus of claim 3, wherein the communication frequency band includes a 13.56 MHz band.

5. The apparatus of claim 3, wherein the power transmission frequency band includes a 6.78 MHz band or 100˜200 KHz band.

6. The apparatus of claim 3, wherein the near-field wireless communication antenna and the WPT coil are in an oval shape, sharing a center, each being arranged inside or outside, relative to the oval.

7. A method of controlling wireless power transmission, comprising:
receiving wireless power transmission control signals from a power transmitting device through a near-field wireless communication antenna at a communication frequency;
delivering wireless power transmission control messages based on the received wireless power transmission control signals to a power Integrated Circuit (IC); and
outputting a constant voltage, using supply power received by a Wireless Power Transmission (WPT) coil, based on the wireless power transmission control messages.

8. The method of claim 6, wherein the near-field wireless communication includes Near Field Communication (NFC) communication.

9. The method of claim 6, wherein the communication frequency band and the power transmission frequency band are different from each other.

10. The method of claim 9, wherein the communication frequency band includes a 13.56 MHz band.

11. The method of claim 9, wherein the power transmission frequency band includes a 6.78 MHz band or 100˜200 KHz band.
